(19) United States
(12) Patent Application Publication
(10) Pub. No.: US 2008/0040324 A1
(43) Pub. Date: Feb. 14, 2008

(54) Search result-based advertisements

(75) Inventors: Reza Sadri, Irvine, CA (US); Payman Arabshahi, Bellevue, WA (US); Carlos P. Fernandez, Laguna Niguel, CA (US); Jafar Adibi, Los Angeles, CA (US); Faramarz Jalalian, Aliso Viejo, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Clenova, LLC

(21) Appl. No.: 11/502,988

(22) Filed: Aug. 11, 2006

(51) Int. Cl. G06F 17/30; G06F 7/00

(52) U.S. Cl. 707/3

(57) ABSTRACT

An embodiment of the present invention is a technique for advertisement placement. A search result is obtained from a query provided by a user. An advertisement is placed using the search result.

### BACKGROUND

1. Field of the Invention

Embodiments of the invention relate to the field of advertising, and more specifically, to on-line advertisements.

2. Description of Related Art

On-line advertisements have been increasingly popular due to the explosion of Internet usage.

Current techniques for on-line advertisements have a number of shortcomings. These techniques, such as those employed by Google or Yahoo, are typically based on queries submitted by a user during a search session. A user enters one or more keywords as part of a query to search for information. The keyword or keywords are then used as an indication of the user's interest. Advertisements are then displayed on-line based on this indication. A primary shortcoming of selecting advertisements based solely on the search query is that this technique does not utilize the additional information returned in the results of the search. Since a successful search, by definition, uses information collected from the user to aggregate a superset of related information, the search results can be used to more accurately, and more completely, identify the interests of the user. Advertisements that are selected based on this information are, in turn, more relevant to the user both in specificity and in breadth. In contrast, advertisements that are based solely on the search query are at best incomplete, and at worst, completely irrelevant.

Another problem with a system which uses search queries to determine and place on-line advertisements is its susceptibility to unwanted, unwarranted web spam. These are typically web pages comprised of advertisements and links to other Web sites that contain mostly ads. The pages may pretend to provide assistance or facts about a particular subject, but the help is often meaningless and the information shallow. Web spam pages use repetitive text in the copy or meta tags in order to achieve a higher ranking in search engine results. They are directly based on search queries input by a user and use such query keywords for their automatic (dynamic), or pre-determined (a priori) generation and placement. However, a system which uses search results to arrive at online advertisements, is by nature highly resistant to a wide variety of web spam. In such a system, there are typically a plethora of paths that arrive at the results, from a user query (this is a many-to-one mapping from user query space, to search result space). In this case, in order to spam the results of a query, the spammer agent has to spam all such paths. These paths are typically unknown a priori. Because of this, and due to the sheer number of such paths, it becomes almost impossible to fully pre-determine and fully pre-process them for generation or placement of a spam web site. Additionally, when generation of search results in mediated through complex post-processing algorithms such as correlation of multiple data streams, documents, or files, and identification of various objects and ranking the results based on their information content or entropy, spam is filtered and removed, virtually automatically, before even making it to the results page.

### BRIEF DESCRIPTION OF THE DRAWINGS

Embodiments of the invention may best be understood by referring to the following description and accompanying drawings that are used to illustrate embodiments of the invention. In the drawings:

FIG. 1A is a diagram illustrating a system in which one embodiment of the invention can be practiced.

FIG. 1B is a diagram illustrating a client system according to one embodiment of the invention.

FIG. 2 is a diagram illustrating an advertisement engine according to one embodiment of the invention.

FIG. 3 is a diagram illustrating a process for ad placement according to one embodiment of the invention.

FIG. 4 is a diagram illustrating a process to obtain the search result according to one embodiment of the invention.

FIG. 5 is a diagram illustrating a process to place an ad on a result page according to one embodiment of the invention.

FIG. 6 is a diagram illustrating a process to place an ad on a Web site according to one embodiment of the invention.

FIG. 7 is a diagram illustrating a process to place an ad with bidding according to one embodiment of the invention.

FIG. 8 is a diagram illustrating a process to select placement of an ad at a Web site according to one embodiment of the invention.

### DESCRIPTION

An embodiment of the present invention is a technique for advertisement placement. A search result is obtained from a query provided by a user. An advertisement is placed using the search result.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention is a technique to place an advertisement (ad). The technique includes (1) obtaining a search result from a query provided by a user; and (2) placing the advertisement using the search result. The search result may be displayed on a result page. The ad placement may be performed in two ways: (i) placing the ad dynamically on the result page, in response to the user query, or (ii) placing the ad dynamically on the Web site which forms the search result of the user query. The ad may be selected or based on the search result, the query, a profile of the user, a search history, or any combination of these. The ad placement may also be based on a bid submitted by an agent of the ad. Unlike the prior art techniques, one embodiment of the invention places the ads according to the search result instead of the query or keywords of the query. The technique, therefore, provides a specific, limited, and highly focused set of ads that are relevant to the user.

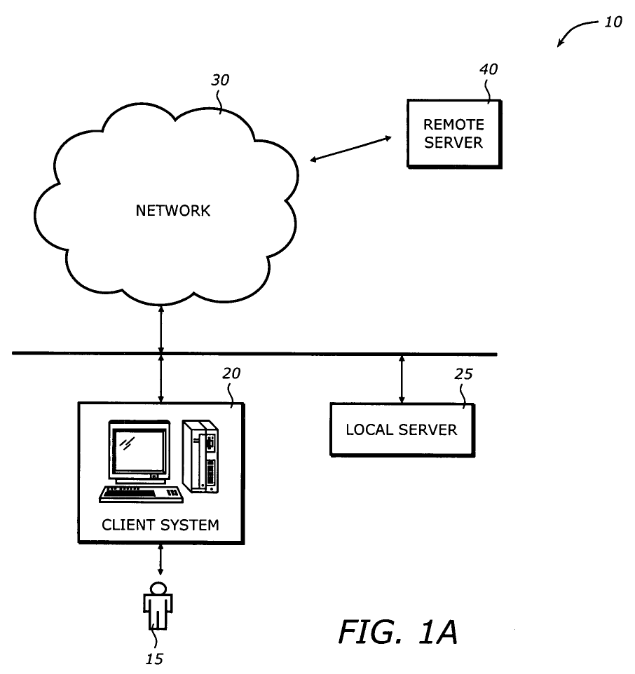

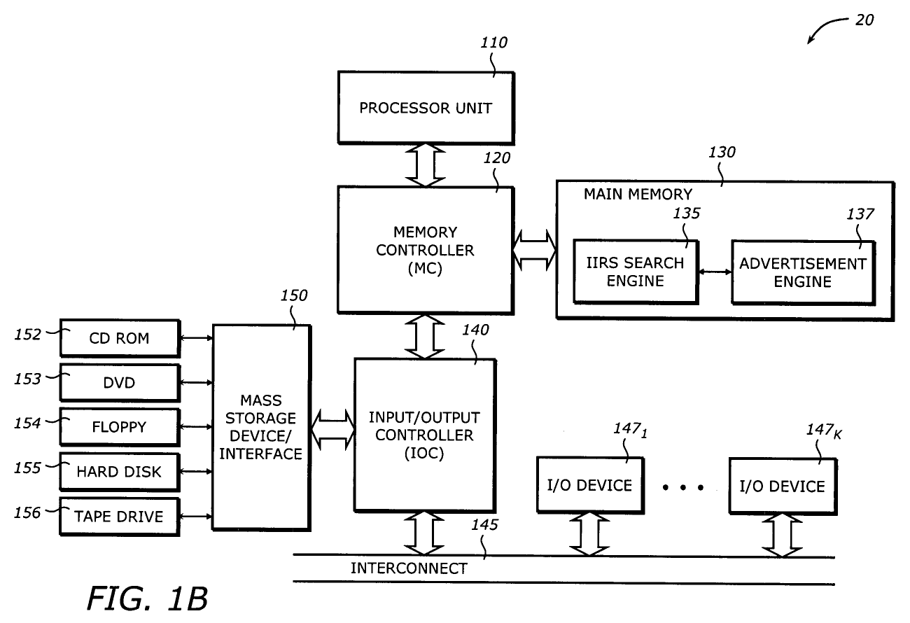

FIG. 1A is a diagram illustrating a system 10 in which one embodiment of the invention can be practiced. The system 10 includes a user 15, a client system 20, a local server 25, a network 30, and a remote server 40.

The user 15 may be a person, an entity, a client, a computer system, or a workstation, or any entity that performs information retrieval or searches for information. The client system 20 may be a computer system, a workstation, a notebook, a laptop, a personal digital assistant (PDA), a mobile unit, or any device that may contain an advertisement engine, an intelligent information retrieval system, or a search engine.

The local server 25 may be any computer system or server that is local to the client system 20. The local server 25 may be directly connected to the client system 20 via a local communication interface including wireless communication. The local server 25 may have a mass storage unit that contains an information base from which the user 15 wishes to search for information. The information base may be a database, files, or other media (e.g., audio, video, graphics, image) files. The local server 25 includes hardware and software to support the operations of an advertisement engine.

The network 30 may be any network that links the client system 20 and/or the local server 25 to other networks, client systems, or remote servers such as the remote server 40. The network 30 may be an intranet, extranet, local area network (LAN), wide area network (WAN), Internet, etc. The network 30 may be wired or wireless.

The remote server 40 may be any server that is connected to the network 30. It may contain the information base from which the user 15 may retrieve the search information. The information base may be a database, files, or other media (e.g., audio, video, graphics, image) files.

FIG. 1B is a diagram illustrating a client system 20 in which one embodiment of the invention can be practiced. The system 20 may be a platform, a unit, a fully or partly configured system. It includes a processor unit 110, a memory controller (MC) 120, a main memory 130, an input/output controller (IOC) 140, an interconnect 145, a mass storage interface 150, and input/output (I/O) devices 147₁ to 147_{K}.

The processor unit 110 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture. The processor unit 110 may be comprised of 32-bit or 64-bit microprocessors.

The MC 120 provides control and configuration of memory and input/output devices such as the main memory 130 and the IOC 140. The MC 120 may be integrated into a chipset that integrates multiple functionalities such as graphics, media, isolated execution mode, host-to-peripheral bus interface, memory control, power management, etc. The MC 120 or the memory controller functionality in the MC 120 may be integrated in the processor unit 110. In some embodiments, the memory controller, either internal or external to the processor unit 110, may work for all cores or processors in the processor unit 110. In other embodiments, it may include different portions that may work separately for different cores or processors in the processor unit 110.

The memory 130 stores system code and data. The main memory 130 is typically implemented with dynamic random access memory (DRAM), static random access memory (SRAM), or any other types of memories including those that do not need to be refreshed. The memory 130 may include multiple channels of memory devices such as DRAMs. The memory 130 may include an advertisement engine 135. The advertisement engine 135 may be implemented by hardware, software, firmware, or any combination thereof. The memory 130 may contain the advertisement engine 135 completely or partly. When the memory 130 contains the advertisement engine 135 partly, the remaining parts of the advertisement engine 135 may be located externally to memory 130 or the client system 20. The memory may also include an intelligent information retrieval system (IIRS) 137. The IIRS 137 may include a user interface, a search engine, an analyzer, a search refiner, a knowledge base, and a knowledge base constructor. It is contemplated that the IIRS 137 may contain more or less than the above components. Any of the above elements may be implemented partly or fully by hardware, software, firmware or any combination thereof. The IIRS 137 may perform any of the following: (1) searching information using a set of search inputs representing a query from a user to produce a search result; (2) analyzing the search result using at least one of a conjunctive search, a link discovery, and a knowledge base to generate an enhanced search result; (3) refining the search using the enhanced search result; and (4) constructing the knowledge base using at least one of a Bayesian network, an expert system, and a rule-based system. The search result may include a plurality of search descriptors that characterize or describe the search results.

The IOC 140 has a number of functionalities that are designed to support I/O functions. The IOC 140 may also be integrated into a chipset together or separate from the MC 120 to perform I/O functions. The IOC 140 may include a number of interface and I/O functions such as a peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, Direct Media Interface (DMI), etc.

The interconnect 145 provides an interface to peripheral devices. The interconnect 145 may be point-to-point or connected to multiple devices. For clarity, not all interconnects are shown. It is contemplated that the interconnect 145 may include any interconnect or bus such as Peripheral Component Interconnect (PCI), PCI Express, Universal Serial Bus (USB), Small Computer System Interface (SCSI), serial SCSI, Direct Media Interface (DMI), etc.

The mass storage interface 150 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 152, digital video/versatile disc (DVD) 153, floppy drive 154, hard drive 155, tape drive 156, and any other magnetic or optic storage devices. The mass storage device provides a mechanism to read machine-accessible media.

The I/O devices 147₁ to 147_{K} may include any I/O devices to perform I/0 functions. Examples of I/O devices 147₁ to 147_{K} include a controller for input devices (e.g., keyboard, mouse, trackball, pointing device), media card (e.g., audio, video, graphic), network card, and any other peripheral controllers.

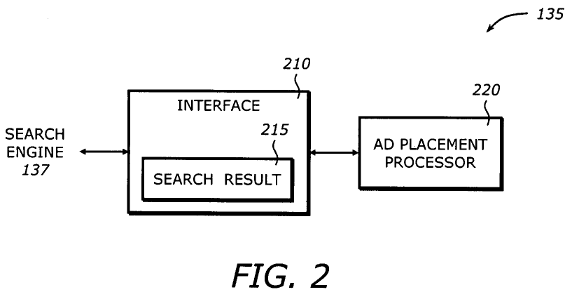

FIG. 2 is a diagram illustrating the advertisement engine 135 according to one embodiment of the invention. The advertisement engine 135 includes an interface 210 and an ad placement processor 220.

The interface 210 is interfaced to the IIRS 137 or the search engine of the IIRS 137. The interface 210 obtains a search result 215 generated by the IIRS 137 or the search engine of the IIRS 137. The search result 215 may include descriptors of the search result. The descriptors may represent an enhanced search result that includes information relevant to the query. The query may include a number of keywords or any other types of information such as tag data, image, media input, etc. The interface 210 may include a result page generator to generate a result page having descriptors related to the search result.

The ad placement processor 220 dynamically places the ad using the search result. The ad placement processor 220 may place the ad on the result page or on a Web site that forms the search result. The ad itself may correspond to, or be based on, any one of the query, the search result, a profile of the user, a search history, and any combination of them. The query may include any search input such as keywords. The search result may include any descriptor relevant to the result of the search. The profile of the user may include any characteristic of the user such as demographic information, preferences, personal information, etc. The search history may include any past search result pertinent to the user.

The ad placement processor 220 may perform a number of operations to support the placement of advertisements during a search session. Examples of these operations include (1) selecting the ad based on any combination of the selection parameters including the search result, the query, the user profile, the search history, or bid values; (2) placing the ad on the result page; (3) placing the ad on the Web site that forms the search result; (4) retrieving a cached Web page; (5) sending the ad to a Web site; (6) receiving bids from advertisers; (7) redirecting the user to a Web site; and (8) providing ad selection parameters to a Web site.

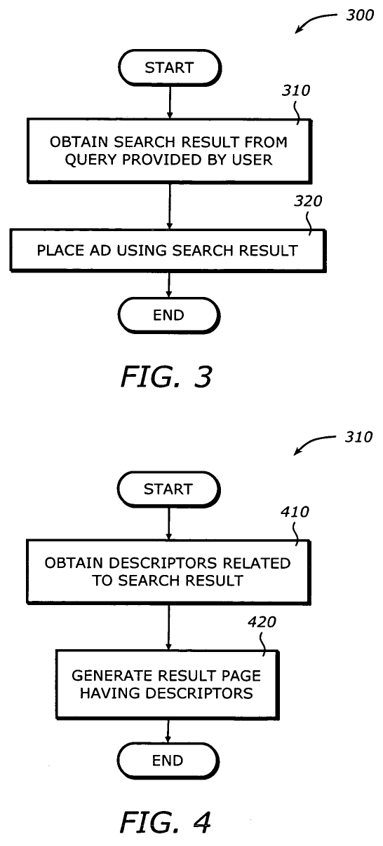

FIG. 3 is a diagram illustrating a process 300 for ad placement according to one embodiment of the invention.

Upon START, the process 300 obtains a search result from a query provided by a user (Block 310). The descriptors of the search result may be obtained and form a result page. The result page may be generated by a local server that runs the search engine.

Next, the process 300 places an advertisement using the search result (Block 320). The placement of the ad may be on the result page or a Web site of the advertiser. The process 300 is then terminated.

FIG. 4 is a diagram illustrating the process 310 to obtain the search result according to one embodiment of the invention.

Upon START, the process 310 obtains descriptors related to the search result (Block 410). The descriptors may be any information that is relevant to the search result. For example, suppose the query includes two keywords “The Big Sur Marathon” and “faculty of Department of Computer Science of Stanford University”. The search result may include Professor Jones who is on the faculty of the faculty of the Department of Computer Science of Stanford University and also a participant in the Big Sur Marathon. Professor Jones lives in Carmel and has a hobby of kite flying. The descriptors, therefore, may include “Carmel” and “kite flying”. Next, the process 310 generates a result page having the descriptors (Block 420). The result page may include the name of Professor Jones and his personal information such as “Carmel” and “kite flying”. The process 310 is then terminated.

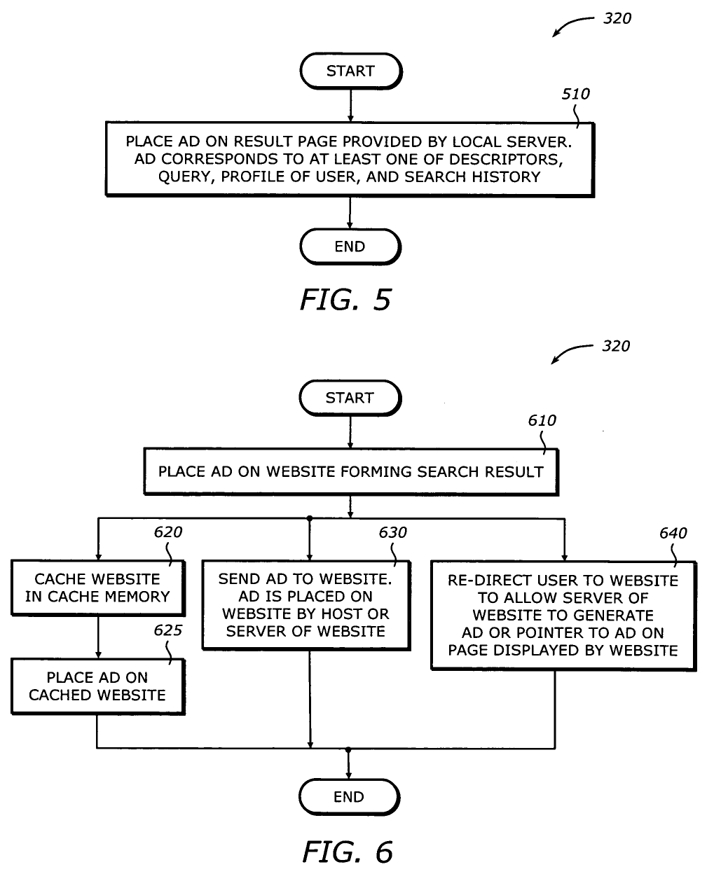

FIG. 5 is a diagram illustrating the process 320 to place an ad on a result page according to one embodiment of the invention.

Upon START, the process 320 places an ad on the result page (Block 510). The result page may be provided by a local server that powers the search engine. The ad corresponds to at least one of the descriptors, the query, a profile of the user, and a search history. In the above example, the ad may include a hotel located in Carmel, or a retailer who sells kites. The process 320 may rank the types of ad by combining these parameters. For example, suppose the profile of the user indicates that the user is also an enthusiast in kite flying, the ad may focus on this common characteristic of the user and the descriptors of the search result and may display all retailers of kites in the locality where the user lives. The process 320 is then terminated.

FIG. 6 is a diagram illustrating the process 320 to place an ad on a Web site according to one embodiment of the invention.

Upon START, the process 320 dynamically places an ad on a Web site that forms the search result (Block 610). The search result may provide a link to a Web site of an advertiser of the relevant ad. For example, suppose a user is looking for a hotel which is close to a reproduction shop's location within a city zip code. The search result may include Marriott and Kinko's in that zip code. Then, the process 320 may display the Kinko's ad on the Marriott's web site. Next, the process 320 may go to one of the three options or branches.

In the first option, the process 320 caches the Web site in a cache memory (Block 620). Then the process 320 places the ad on the cached Web site (Block 625) and is then terminated. In this option, the local server may have a cached version of the Web site of interest. Once the Web site is identified, the process 320 may retrieve the Web page directly from the cache without interaction with the primary Web site. The advantage is that the dynamic generation of an ad-infused cached page may be very fast. The disadvantage is that the cache may be out of date due to recent updates of the Web site.

In the second option, the process 320 sends the ad to the Web site (Block 630). The ad is then placed on the Web site by the host or a server of the Web site. The Web site may then dynamically generate a version of itself, with the ad embedded in the Web page, and present to that specific user during that specific session. The user may then have the opportunity to bookmark the ad-embedded page or the original site with no ads. The process 320 may either communicate the complete ad to the Web site of interest or communicate a pointer to such as ad and host on the local server. The process 320 is then terminated.

In the third option, the process 320 re-directs the user to the Web site to allow the server of the Web site to generate the ad or a pointer to the ad on a page displayed by the Web site (Block 640). The Web site operators may have a locally built software application installed, and properly interfaced with the Web server under some agreement with the operator of the local server. The advantage is that no live communication is needed from the local server to enable the ad placement. The process 320 is then terminated.

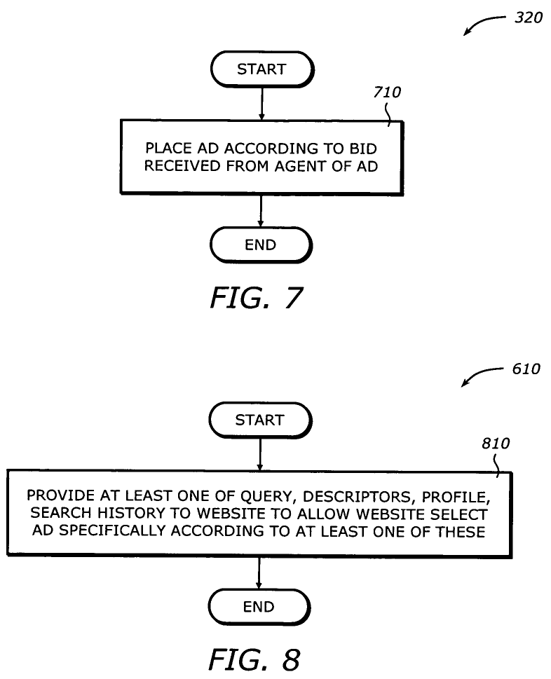

FIG. 7 is a diagram illustrating the process 320 to place an ad with bidding according to one embodiment of the invention.

Upon START, the process 320 places the ad according to a bid received by an agent of the ad (Block 710). The agent may be the advertiser, the manufacturer of the product in the ad, an advertisement broker, a representative of the advertiser, or any entity that has a legal authority to bid or purchase the ad. The bidding process may be based on the search result and not on the search queries. The ad placement may be tailored according to the bid value. For example, the higher the bid, the higher and more prominent the physical placement of the ad may become on the result page. The process 320 is then terminated.

FIG. 8 is a diagram illustrating the process 610 to select the placement of an ad at a Web site according to one embodiment of the invention.

Upon START, the process 610 provides at least one of the query, the descriptors, the profile of the user, and a search history to the Web site to allow the Web site to select the ad specifically according to at least one of these (Block 810). The process 610 may allow the Web site operator to fine tune the ad message to the user. For example, the Web site may direct the user to a page that has the information specifically geared toward any one of these parameters or any combination of them. The process 610 is then terminated.

Elements of embodiments of the invention may be implemented by hardware, firmware, software or any combination thereof. The term hardware generally refers to an element having a physical structure such as electronic, electromagnetic, optical, electro-optical, mechanical, electro-mechanical parts, components, or devices, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), an erasable programmable ROM (EPROM), a floppy diskette, a compact disk (CD) ROM, an optical disk, a hard disk, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described above. The machine accessible medium may also include program code embedded therein. The program code may include machine readable code to perform the operations described in the following. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

One embodiment of the invention may be described as a process, which is usually depicted as a flowchart, a flow diagram, a structure diagram, or a block diagram. Although a flowchart may describe the operations as a sequential process, many of the operations can be performed in parallel or concurrently. A loop or iterations in a flowchart may be described by a single iteration. It is understood that a loop index or loop indices or counter or counters are maintained to update the associated counters or pointers. In addition, the order of the operations may be re-arranged. A process terminates when its operations are completed. A process may correspond to a method, a program, a procedure, etc. A block diagram may contain blocks or modules that describe an element, an item, a component, a device, a unit, a subunit, a structure, a method, a process, a function, an operation, a functionality, or a task, etc. A functionality or an operation may be performed automatically or manually.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
obtaining a search result from a query provided by a user; and
placing an advertisement using the search result.

2. The method of claim 1 wherein obtaining the search result comprises:
obtaining descriptors related to the search result; and
generating a result page having the descriptors.

3. The method of claim 2 wherein placing the advertisement comprises:
placing the advertisement on the result page, the advertisement corresponding to at least one of the descriptors, the query, a profile of the user, and a search history.

4. The method of claim 3 wherein placing the advertisement comprises:
placing the advertisement on the result page provided by a local server.

5. The method of claim 1 wherein placing the advertisement comprises:
placing the advertisement on a Web site forming the search result.

6. The method of claim 5 wherein placing the advertisement comprises:
caching the Web site in a cache memory; and
placing the advertisement on the cached Web site.

7. The method of claim 5 wherein placing the advertisement comprises:
sending the advertisement to the Web site, the advertisement being placed on the Web site by a host or a server of the Web site.

8. The method of claim 5 wherein placing the advertisement comprises:
redirecting the user to the Web site to allow a server of the Website to generate the advertisement or a pointer to the advertisement on a page displayed by the Web site.

9. The method of claim 1 wherein placing the advertisement comprises:
placing the advertisement according to a bid received from an agent of the advertisement.

10. The method of claim 5 wherein placing the advertisement comprises:
providing at least one of the query, descriptors of the search result, a profile of the user, and a search history to the Web site to allow the Web site to select the advertisement specifically according to the at least one of the query, descriptors of the search result, a profile of the user, and a search history.

11. An advertisement engine comprising:
an interface coupled to a search engine to obtain a search result from a query provided by a user; and
an advertisement placement processor coupled to the interface to place an advertisement using the search result.

12. The advertisement engine of claim 11 wherein the interface comprises:
a result page generator to generate a result page having descriptors related to the search result.

13. The advertisement engine of claim 12 wherein the advertisement placement processor places the advertisement on the result page, the advertisement corresponding to at least one of the descriptors, the query, a profile of the user, and a search history.

14. The advertisement engine of claim 12 wherein the advertisement placement processor places the advertisement on the result page provided by a local server.

15. The advertisement engine of claim 11 wherein the advertisement placement processor places the advertisement on a Web site forming the search result.

16. The advertisement engine of claim 15 wherein the advertisement placement processor places the advertisement on a cached Web site.

17. The advertisement engine of claim 15 the advertisement placement processor sends the advertisement to the Web site, the advertisement being placed on the Web site by a host or a server of the Web site.

18. The advertisement engine of claim 15 wherein the advertisement placement processor redirects the user to the Web site to allow a server of the Website to generate the advertisement or a pointer to the advertisement on a page displayed by the Web site.

19. The advertisement engine of claim 11 wherein the advertisement placement processor places the advertisement according to a bid received from an agent of the advertisement.

20. The advertisement engine of claim 15 wherein the advertisement placement processor provides at least one of the query, descriptors of the search result, a profile of the user, and a search history to the Web site to allow the Web site to select the advertisement specifically according to the at least one of the query, descriptors of the search result, a profile of the user, and a search history.

21. An article of manufacture comprising:
a machine-accessible medium including data that, when accessed by a machine, cause the machine to perform operations comprising:
obtaining a search result from a query provided by a user; and
placing an advertisement using the search result.

22. The article of manufacture of claim 21 wherein the data causing the machine to perform obtaining a search result comprises data that, when accessed by a machine, cause the machine to perform operations comprising:
obtaining descriptors related to the search result; and
generating a result page having the descriptors.

23. The article of manufacture of claim 22 wherein the data causing the machine to perform placing the advertisement comprises data that, when accessed by a machine, cause the machine to perform operations comprising:
placing the advertisement on the result page, the advertisement corresponding to at least one of the descriptors, the query, a profile of the user, and a search history.

24. The article of manufacture of claim 22 wherein the data causing the machine to perform placing the advertisement comprises data that, when accessed by a machine, cause the machine to perform operations comprising:
placing the advertisement on the result page provided by a local server.

25. The article of manufacture of claim 21 wherein the data causing the machine to perform placing the advertisement comprises data that, when accessed by a machine, cause the machine to perform operations comprising:
placing the advertisement on a Web site forming the search result.

26. The article of manufacture of claim 25 wherein the data causing the machine to perform placing the advertisement comprises data that, when accessed by a machine, cause the machine to perform operations comprising:
caching the Web site in a cache memory; and
placing the advertisement on the cached Web site.

27. The article of manufacture of claim 25 wherein the data causing the machine to perform placing the advertisement comprises data that, when accessed by a machine, cause the machine to perform operations comprising:
sending the advertisement to the Web site, the advertisement being placed on the Web site by a host or a server of the Web site.

28. The article of manufacture of claim 25 wherein the data causing the machine to perform placing the advertisement comprises data that, when accessed by a machine, cause the machine to perform operations comprising:
redirecting the user to the Web site to allow a server of the Website to generate the advertisement or a pointer to the advertisement on a page displayed by the Web site.

29. The article of manufacture of claim 21 wherein the data causing the machine to perform placing the advertisement comprises data that, when accessed by a machine, cause the machine to perform operations comprising:
placing the advertisement according to a bid received from an agent of the advertisement.

30. The article of manufacture of claim 25 wherein the data causing the machine to perform placing the advertisement comprises data that, when accessed by a machine, cause the machine to perform operations comprising:
providing at least one of the query, descriptors of the search result, a profile of the user, and a search history to the Web site to allow the Web site to select the advertisement specifically according to the at least one of the query, descriptors of the search result, a profile of the user, and a search history.
